(19) United States
(12) Patent Application Publication
(10) Pub. No.: US 2015/0161674 A1
(43) Pub. Date: Jun. 11, 2015

(54) GENERATION OF FASHION ENSEMBLES BASED ON ANCHOR ARTICLE

(71) Applicant: C'EST MOI! LLC, Southgate, MI (US)

(72) Inventors: Laura Khoury, Bloomfield Township, MI (US); Mark J. Menard, Clarkston, MI (US); David R. Long, Beverly Hills, MI (US)

(73) Assignee: C'EST MOI! LLC, Southgate, MI (US)

(21) Appl. No.: 14/413,889

(22) PCT Filed: Jul. 12, 2013
(86) PCT No.: PCT/US2013/050214

§ 371 Date: Jan. 9, 2015

Related U.S. Application Data
(60) Provisional application No. 61/671,182, filed on Jul. 13, 2012.
(60) Provisional application No. 61/790,390, filed on Mar. 15, 2013.

(51) Int. Cl. G06Q 30/02; G06F 3/0484; G06F 3/0482; H04L 12/58

(52) U.S. Cl. CPC G06Q 30/0269; H04L 51/10; G06F 3/04842; G06F 3/0482

(57) ABSTRACT

Disclosed are methods, apparatuses and computer instructions for generating groups of articles for ensembles based on an anchor article. In one aspect, the method includes adding attributes of the anchor article to a set of selected attributes, defining a sequence of buckets in an order where each of the buckets includes available items in one or more categories based on a category of an anchor article, and generating a current group of articles by performing the following steps until each bucket has been selected: selecting a bucket in the sequence, applying a filter to remove items having attributes incompatible with the set of selected attributes, calculating weights for articles based on one or more rules and the set of selected attributes, selecting an article from the bucket for a group of articles based on its weight, and adding attributes of the selected article to the set of selected attributes.

### CROSS-REFERENCE TO RELATED APPLICATIONS

This application claims priority to U.S. Provisional Patent Application Nos. 61/671,182, filed Jul. 13, 2012, and 61/790,390, filed Mar. 15, 2013, both of which are hereby incorporated by reference in their entireties.

### TECHNICAL FIELD

This disclosure relates to the generation of fashion ensembles based on an anchor article.

### BACKGROUND

Individuals and groups, such as businesses, charities, etc., spend a great deal of effort, in both time and money, on acquiring goods and services they need or desire. The effort required is often due to the number of available choices and can also relate to the need to coordinate any new acquisition with goods or services already acquired.

### SUMMARY

Described herein are techniques including for the generation of fashion ensembles based on an anchor article.

The disclosed implementations include a method for generating one or more groups of articles for one or more ensembles based on at least one anchor article. The method includes adding at least one attribute of the at least one anchor article to a set of selected attributes, defining a sequence of buckets in an order based on a category of the at least one anchor article, wherein each of the buckets include selected articles of a set of available articles belonging to at least one category of a plurality of categories, and generating a current group of articles of the one or more groups of articles by adding the at least one anchor article to the current group of articles and performing the following steps until each bucket of the sequence of buckets has been selected: selecting a current bucket from the sequence of buckets based on the order of buckets, applying a filter to at least one of the current bucket or a later bucket of the sequence of buckets to remove articles having at least one attribute determined to be incompatible with at least one attribute in the set of selected attributes, calculating a weight for at least some articles in the current bucket based on one or more rules and the set of selected attributes, selecting an article from the current bucket for inclusion in the current group of articles based on a ranking of articles according to the calculated weights, and adding at least one attribute of the selected article from the current bucket to the set of selected attributes.

The disclosed implementations also include an apparatus for generating one or more groups of articles for one or more ensembles based on at least one anchor article. The apparatus includes a memory and a processor configured to execute instructions stored in the memory to perform the steps of the above described method.

The disclosed implementations also include a non-transitory computer readable medium including computer readable instructions for generating one or more groups of articles for one or more ensembles based on at least one anchor article; wherein the instructions, when executed by a processor, cause the processor to perform the steps of the above described method.

Variations in these and other examples and embodiments will be described in detail hereafter.

### BRIEF DESCRIPTION OF THE DRAWINGS

The description herein makes reference to the accompanying drawings wherein like reference numerals refer to like parts throughout the several views, and wherein:

FIG. 1 is a schematic of a system in which embodiments of the teachings herein may be incorporated;

FIG. 2 is a block diagram of a computing device that can implement a station of FIG. 1;

FIG. 3 is a flow chart of one implementation of a recommendation engine process performed according to the teachings herein;

FIG. 4A is a swim lane diagram of another implementation of a recommendation engine process performed according to the teachings herein; and

FIG. 4B is a continuation of the swim lane diagram of FIG. 4A.

### DETAILED DESCRIPTION

Described herein are techniques for the generation of ensembles of articles based on an anchor article. By way of example, a fashion ensemble is a group of fashion related articles that can include clothes, jewelry, handbags, shoes, and other accessories. A selection of a group of articles can be based on situational information (such as current fashion trends, season, event, etc.), article attributes (such as color, style, configuration, etc.), and user attributes (such as body type, body color, style, etc.).

The recommendation engine implementations described herein have the capability of generating groups of articles based on at least one anchor article that can be selected by an end-user or can be automatically selected based on pre-determined criteria. The anchor article can be used to determine a plurality of buckets each having one or more associated categories and an associated order of buckets that controls the sequence of selection of articles from the buckets for inclusion in a group of articles. The articles included in the buckets can be pre-filtered based on situational filters and user filters. Articles can then be iteratively selected from the buckets for inclusion in the group of articles based on weighted rankings generated using rules. In some instances, the rules and/or filters can take into account the attributes of previously selected articles (e.g., to avoid selecting articles with incompatible styles or colors).

Implementations of the recommendation engine can be configured to generate multiple groups of articles from the selected anchor article(s). In one example, the recommendation engine can be configured to select a lower ranked item from one or more of the buckets to generate additional groups of articles. Each group of articles can be assigned a weight based on the weights of the articles selected for each respective group. The generated groups of articles can be sorted by weight and groups of articles with lower weights can be discarded. Groups of articles can then be selected using an algorithm (such as random selection or selection of a highest weighted group in addition to random selection) for use (e.g., to be displayed to an end-user).

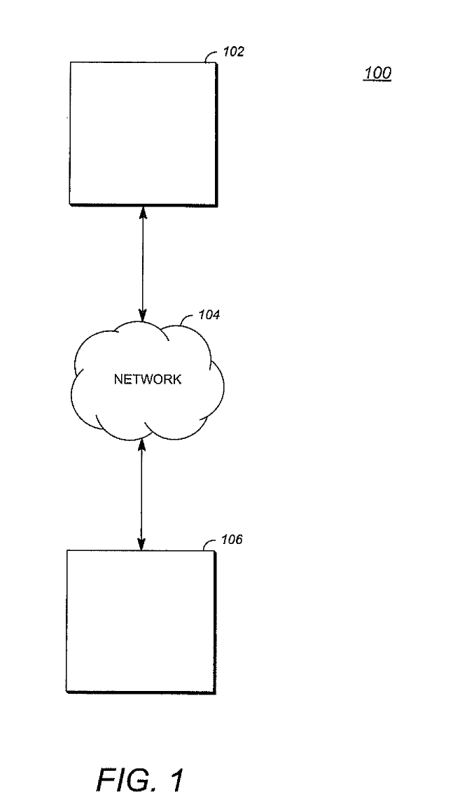

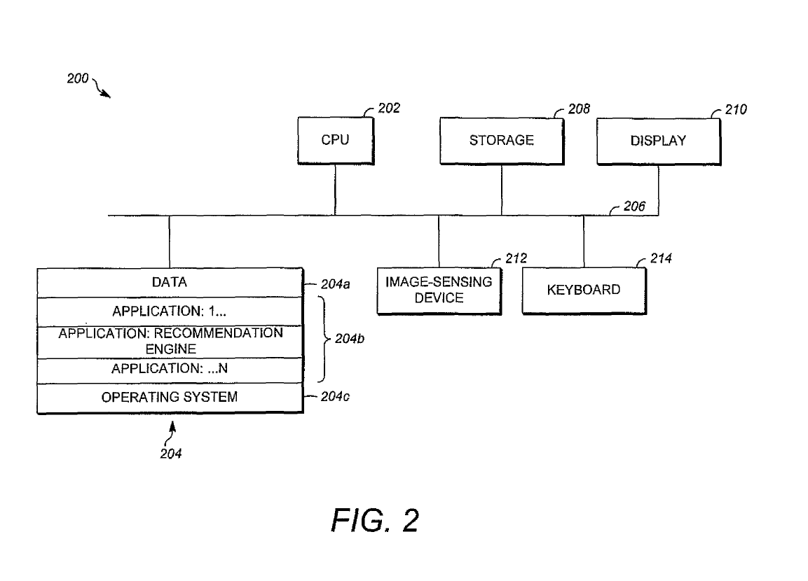

A system 100 in which embodiments of the teachings herein can be implemented includes, as shown in FIG. 1, a server station 102. Server station 102 in this example is a computer having an internal configuration of hardware such as that described in FIG. 2. However, other suitable implementations of server station 102 are possible. For example, the processing of server station 102 can be distributed among multiple devices.

A network 104 can connect server station 102 and an end-user station 106 for acquiring and/or managing consumption items. In one example described herein, server station 102 interacts with end-user station 106 through a graphical user interface (e.g., a web-based browser). Thus, network 104 can be the Internet. Network 104 can also be a local area network (LAN), wide area network (WAN), virtual private network (VPN), cellular telephone network or any other means of transferring information between server station 102 and end-user station 106.

End-user station 106, in the examples described herein, is a computer having an internal configuration of hardware such as that described in FIG. 2. However, other suitable implementations of end-user station 106 are possible as described with respect to FIG. 2.

Other implementations of system 100 are possible. For example, an implementation can omit network 104. That is, all processing of server station 102 described hereinafter could be incorporated into end-user station 106.

FIG. 2 is a block diagram of a computing device 200 that can implement server station 102 and/or end-user station 106 of FIG. 1. Computing device 200 can be in the form of a computing system including multiple computing devices, or in the form of a single computing device, for example, a mobile phone, a tablet computer, a laptop computer, a notebook computer, a desktop computer, and the like.

A CPU 202 in computing device 200 can be a conventional central processing unit. Alternatively, CPU 202 can be any other type of device, or multiple devices, capable of manipulating or processing information now-existing or hereafter developed. Although the teachings disclosed herein can be practiced with a single processor as shown, e.g., CPU 202, advantages in speed and efficiency can be achieved using more than one processor.

A memory 204 in computing device 200 may be a read only memory (ROM) device, a random access memory (RAM) device or any other suitable type of storage device. Memory 204 can include code and data 204a that is accessed by CPU 202 using a bus 206. Memory 204 can further include application programs 204b and an operating system 204c, where the application programs 204b include at least one program that permits CPU 202 to perform the methods and processes described here. For example, application programs 204b can include applications 1 through N, which further include a recommendation engine application that performs the methods described here. Computing device 200 can also include a secondary storage 208, which may be a memory card used with a computing device 200 that is mobile in an example. Secondary storage 208 can be a disk drive or removable media such as a CompactFlash (CF) card, Secure Digital (SD) card, or the like. Because a significant amount of information may be involved in the processes described herein, the information can be stored in whole or in part in secondary storage 208 and loaded into memory 204 as needed for processing.

Computing device 200 can also include one or more output devices, such as a display 210. Display 210 may be, in one example, a touch sensitive display that combines a display with a touch sensitive element that is able to sense touch inputs. Display 210 can be coupled to CPU 202 via bus 206. Other devices that permit a user to program or otherwise use computing device 200 may be provided in addition to or as an alternative to display 210. When the output device is or includes display 210, display 210 can be implemented in various ways, including by a liquid crystal display (LCD) or a cathode-ray tube (CRT) or light emitting diode (LED) display, such as an OLED display.

Other devices that permit a user to program or otherwise use computing device 200 in FIG. 2 include an image-sensing device 212, for example a camera, or any other image-sensing device 212 now existing or hereafter developed that can sense an image such as the image of a user operating computing device 200, and a keyboard 214 or other manual or verbal input device (e.g., a sound-sensing device such as a microphone). Image-sensing device 212 can be positioned such that it is directed toward the user operating computing device 200 and/or can be arranged in a direction away from the user so as to obtain images of items to be acquired or managed.

Although FIG. 2 depicts CPU 202 and memory 204 of computing device 200 as being integrated into a single unit, other configurations can be utilized. The operations of CPU 202 can be distributed across multiple machines (each machine having one or more of processors) that can be coupled directly or across a local area or other network. Memory 204 can be distributed across multiple machines such as a network-based memory or memory in multiple machines performing the operations of computing device 200. Although depicted here as a single bus, bus 206 of computing device 200 can be composed of multiple buses. Further, secondary storage 208 can be directly coupled to the other components of computing device 200 or can be accessed via a network and can comprise a single integrated unit such as a memory card or multiple units such as multiple memory cards. Computing device 200 can thus be implemented in a wide variety of configurations.

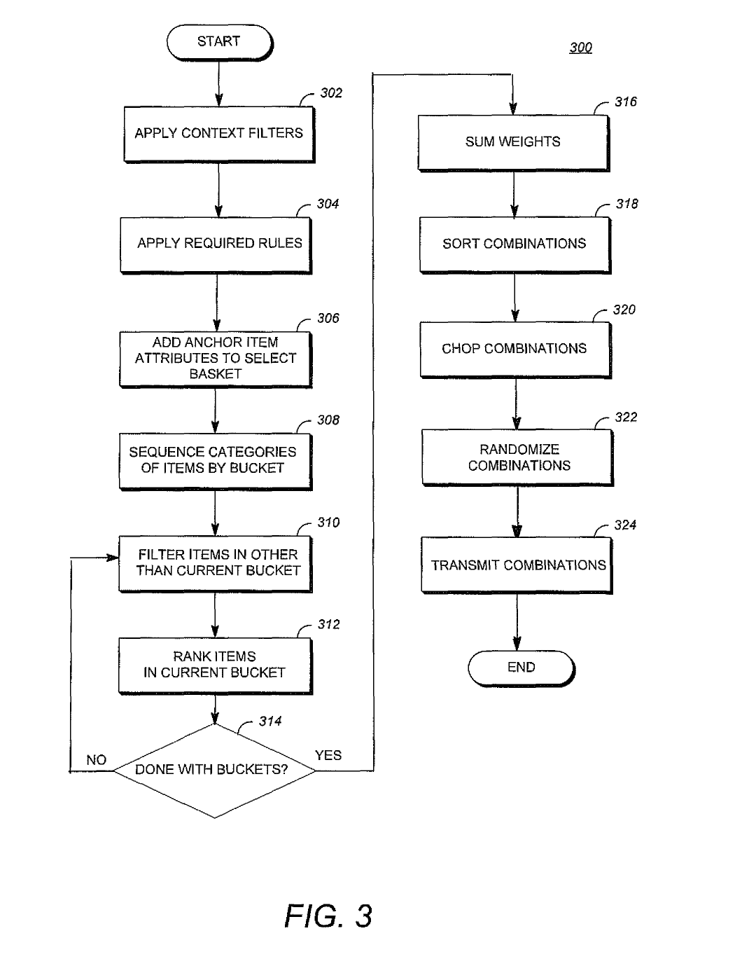

FIG. 3 is a flow chart of one implementation of a recommendation engine process 300 performed according to the teachings herein. Recommendation engine process 300 recommends combinations of items that can be used together from existing items of an end user, from items that can be acquired to need a specific need or goal of the end user, or from a mix of existing and possible new items. Items are also called articles herein, and these terms are used interchangeably. Combinations of items or articles are also referred to as groups of items or articles, and these terms are also used interchangeably.

FIG. 3 is described with respect to one use of the teachings herein, namely the creation of a clothing or apparel combination for an end user (e.g., an ensemble), for ease of understanding. A clothing or apparel combination can include items other than textiles, such as jewlerly, hand bags, shoes, and other accessories. Such a combination can be referred to as a fashion ensemble. However, the process described can be applied to a variety of consumable items. Further, and although consumable items are described, the teachings herein are equally applicable to items that may not be considered consumable, such as furniture for a room or office. Application of the teachings herein to items other than clothing and variations in the implementation of FIG. 3 are discussed in further detail below.

Recommendation engine process 300 can be implemented as one or more software programs executed by computing devices such as server station 102 or end-user station 106. The software programs can include machine-readable instructions that are stored in a memory such as memory 204 that, when executed by a processor such as CPU 202, cause the computing device to perform recommendation engine process 300. Some or all of recommendation engine process 300 can be implemented using hardware. As explained above, some computing devices may have multiple memories and multiple processors, and the steps of recommendation engine process 300 may in such cases be distributed using different processors and memories. Use of the terms “processor” and “memory” in the singular encompasses computing devices that have only one processor or one memory as well as devices having multiple processors or memories that may each be used in the performance of some but not necessarily all of the recited steps.

For simplicity of explanation, recommendation engine process 300 is depicted and described as a series of steps or actions. However, steps in accordance with this disclosure can occur in various orders and/or concurrently. Additionally, steps in accordance with this disclosure may occur with other steps not presented and described herein. Furthermore, not all illustrated steps may be required to implement a method in accordance with the disclosed subject matter.

As shown in FIG. 3, recommendation engine process 300 starts by applying context filters to items available to form a combination in step 302. The available items can be stored locally in a database with their attributes, such as color, category, etc., or can be stored remotely. The items can be arranged in categories and subcategories. In this example, the available items may be articles of clothing in an end user's closet, such as sweaters, jackets, shirts, bottoms, etc. Thus, bottoms could be a category having subcategories such as skirts, pants, culottes, leggings, shorts, etc. The articles in an end-user's closet can be determined based on, for example, user entry, purchase history, or analysis of photographs of the closet.

Items can also include articles available for purchase. For example, the items can include some or all of a universe of articles from a plurality of different retailers. In an implementation, the available items can be limited to a boutique of articles available for purchase that are selected from the universe of articles based on one or more user attributes. For example, the boutique of articles can omit articles that are incompatible with a body type, a style, a budget, a preferred one or more retailers, etc. of an end-user.

Articles can include a number of attributes other than category, subcategory, and color. The set of attributes for each article can be different. The set of attributes for a given article can be determined based on that article's category and subcategory in some implementations. For example, an article that is in the shoe category can include attributes such as material type (e.g., leather, vinyl, fabric, etc.), whether or not the shoe is open toe, and the luster of the shoe (e.g., satin, gloss, etc.). The type of shoe (e.g., high heel, flat, sandal, etc.) can, for example, be described in either a subcategory, separate attribute, or both. Attributes that can be applied across categories can include, for example, brand, cost, retailer, location(s), and quantity.

The context filters can be embodied in files accessible to recommendation engine process 300 and may include rules associated with parameters of various situations such as the season, an occasion and/or a color scheme. The parameters associated with these situations (hereinafter referred to as situational parameters) can be selected by an end user. For example, the situational parameters associated with a season can be summer, winter, spring or fall. The situational parameters associated with an occasion may include business formal, business casual, formal, casual, etc. The situational parameters associated with a color scheme can be a palette, such as cool or warm, or can be one or more colors.

The context filters applied in step 302 may filter out items from the universe of available items. For example, a rule associated with the situational parameter of winter may be that all shorts (a subcategory of bottoms) are filtered out of the available items (e.g., closet or boutique).

Other context filters may be included in addition to or alternatively to the context filters associated with situations. For example, a context filter associated with the end user's personal attributes could be included where personal attributes include, for example, body type, skin color, hair color, etc. When a personal attribute is body type is in an implementation, the parameters associated with the body type (also called personal parameters) may include top heavy body type (lollipop or goblet shape), bottom heavy body type (skittle, bell or pear shape), top and bottom heavy body type (apple, hourglass, vase or cello shape), athletic/no curves body type (brick, cone or column shape). There are a number of known style rules based on personal attributes that can be implemented in a context filter.

For example, rules based on top heavy body shapes may exclude shirts with ruffles or in pastel shades, include skirts (a subcategory of bottoms) that are fitted at the tip and flared at the hemline, include shoes with high and medium to slim heels, exclude boxy jackets and include fitted, single-breasted jackets. The personal parameters can be stored in a user profile that is accessible to recommendation engine process 300 when the context filter for the end user's personal attributes is used. The personal parameters may also include personal preferences that can be used to generate rules. For example, the personal parameters could include subcategories to always filter out, such as turtlenecks (a subcategory of shirts and/or sweaters).

A context filter associated with the end user's personal attributes may be particularly desirable when the available items includes articles from a catalogue of a retailer so as to eliminate a large number of available items that would not suit the personal attributes, including personal preferences, of the end user. Another context filter can include a end-user's budget. A budget can be defined on a per article or per ensemble basis. For example, an end-user can set the filter to eliminate any items in her boutique that have a price greater than a certain price, such as $150.00. Alternatively or in addition, an end-user can set the filter to eliminate any group of articles that have a combined price greater than a certain price, such as $300.00. Alternatively or in addition, an end-user can set the filter to set a budgetary price on certain categories of articles.

Attributes of an end-user profile can, for example, be entered by a user, be learned from user actions, or be detected from an image of a user or other biometric data. For example, in some implementations, attribute(s) relating to the style of a user can be inferred from user actions, such the selection of previously recommended ensembles. As a specific example, an attribute can be set indicating that a user prefers pants based on historical selection of articles that are pants or ensembles having pants. As another specific example, an attribute can be set indicating that a user does not prefer skirts because the user never selects an article that is a skirt nor ensembles having skirts. In some implementations, user information, such as hair color, skin type, and body type can be detected by analyzing the colors and edges in an image. In some implementations, attributes of a user can be detected using biometric information, such as from an internet-enabled scale. In some implementations, attribute(s) relating to the style of a user can be generated based on articles in the end-user's closet.

Next step 304 involves applying required and optionally other rules to create a select basket that includes attributes of all required items. The required items could include, for example, those items required based on the season, occasion and selected color scheme. When the end user selects a category or subcategory, for example, that category or subcategory can be an attribute added to the select basket, along with any other categories and/or attributes required by category combination rules that can be stored and referred to by recommendation engine process 300. Category combination rules provide for combining categories under certain circumstances, discussed in more detail hereinafter, where items in the categories are considered together to identify the best out of the combined group in later steps. When a required rule requires a subcategory, the subcategory plus the category and the subcategory may be added to the select basket. Article rules can also be applied in step 304. Article rules may provide combinations to avoid as described in additional detail hereinafter.

Recommendation engine process 300 next advances to step 306 to add attributes of one more anchor items to the select basket. Anchor items are items to be included in any combination, and they can be selected by the end user. In some implementations, an anchor item can be selected automatically, such as described later. In one embodiment, a minimum number and maximum number of anchor items can be selected or designated. For example, a minimum of one article and a maximum of three articles can be designated. The attributes of the anchor items added to the select basket may be color, category and/or subcategory, among other possible attributes.

Next step 308 involves sequencing categories of items by grouping them into “buckets” based on the selected anchor item(s). A bucket is a collection of items or articles grouped by their category or subcategory. Sequencing the categories in step 308 determines how the items will be bucketed and in what order the items will be selected to make combinations based on the anchor item(s). For example, when the anchor item is a sweater (i.e., it belongs to a category of tops and to a subcategory of sweaters), the following buckets can be sequenced for processing: 1) a bucket combining items in bottoms, suits and dresses categories; 2) a bucket containing items in a shirt category; 3) a bucket containing items in a camisole category; 4) a bucket containing items in a shoes category; 5) a bucket containing items in a handbag category; and 6) a bucket containing items in a coat category.

The above category sequences are provided as examples only where the items are articles of clothing and can vary. The category sequences may be dependent upon the type of items under consideration. Sequences and combinations may take into account combinations to avoid and may be arranged in an order that reduces the number of buckets analyzed depending on earlier choices in the sequence.

After step 308, filtering and ranking starts using the sequence determined in step 308. First, items in buckets other than those in the current bucket under consideration are filtered in step 310. In this example, items in each bucket from which an article has not yet been selected for the combination are eliminated based on filters such as the situation rules and article rules. Article rules can be included to enforce rules specific to attributes of an article. For example, one article rule may be to exclude the consideration of items with a floral pattern when a striped item is already in the combination.

After filtering the buckets in step 310, items in the current bucket are ranked in step 312. Items may be ranked based on their weight, such as in descending order. The weight of an article may be determined based on how many rules the item satisfies or a sum of the weights assigned to each rule. According to one implementation, if three rules have an output that includes a particular article, the weight of the article can be three. As applied to the implementation where items are articles of clothing, for example, a season of summer and an occasion of casual may provide a count of two to a pair of shorts. The pair of shorts may receive an additional point or points for satisfying a specified color scheme.

In certain implementations, the weight can be positive or negative and can be of a value greater than one or less than one. For example, a large negative weight can be used to effectively exclude a particular category of articles.

The filtering and ranking of steps 310 and 312 form an iterative process that selects an item in a bucket based on its weight before proceeding to consider remaining items in the next bucket for inclusion in the combination until a combination (e.g., an outfit) is complete. The items required to make a complete combination may be a predetermined parameter. As shown in FIG. 3, this involves recommendation engine process 300 querying in step 314 whether there are any buckets left to consider. If so, recommendation engine process 300 repeats steps 310 and 312 until the query in step 314 indicates that all buckets have been considered. To generate a first recommended combination, the top weighted item in each bucket may be selected. Other choices of items may be implemented based on, for example, the order of the buckets or the category/subcategory of items in the buckets.

Recommendation engine process 300 may also be expanded to generate a plurality of outfits by repeating the filtering and ranking of steps 310 and 312 while selecting items for a combination based on selecting items based on different weights than were used to make the first combination. For example, assuming the top weighted items in each bucket were selected to make the first combination, a second combination may be formed by selecting the top weighted item of the first bucket while selecting items from subsequent buckets as the next item in the ranking after the top weighted item.

When only one combination is suggested, recommendation engine process 300 can end. When multiple combinations are suggested, however, a relative valuation is placed on each of the combinations so as to provide ultimate recommendations to the end user. In step 316, for example, the valuation of a combination is its total weight as determined by summing the weights of each item in the combination. Other ways of valuing the combinations can be used, such as by providing additional weight to a combination that includes only items already acquired by the end user as compared to a combination that requires an acquisition to be complete.

In step 318, the valuation placed on the combinations is used to sort the combinations. In one example, the total weight of each combination is used to sort the combinations in descending order. That is, the combination with items having the highest total weight is listed first, while the combination with items having the lowest total weight is listed last. Desirably, all combinations having a valuation within a certain percentile of the total are chopped in step 320. The percentile can be referred to as a chopfactor and can vary between zero and less than 100 percent. For example, a chopfactor of 20 or 80 percent would discard those combinations having items with a total weight in the bottom 20 or 80 percent of all combinations.

The order of the remaining combinations may be randomized in step 322. In one example, all combinations remaining after chopping the combinations in step 320 are placed in a random order except for the first combination (e.g., the one determined using the top weighted items from each bucket). The first combination may remain as the first combination. The randomization can operate to avoid the display of combinations that are very similar to each other (e.g., two or more combinations having only one article that is different). At step 324, the combinations are transmitted (e.g., sent for display). All of the combinations could be sent to the end user, or, in an alternative example, a designated maximum number of suggestions is used to limit the number of combinations sent. After step 324, recommendation engine process 300 ends.

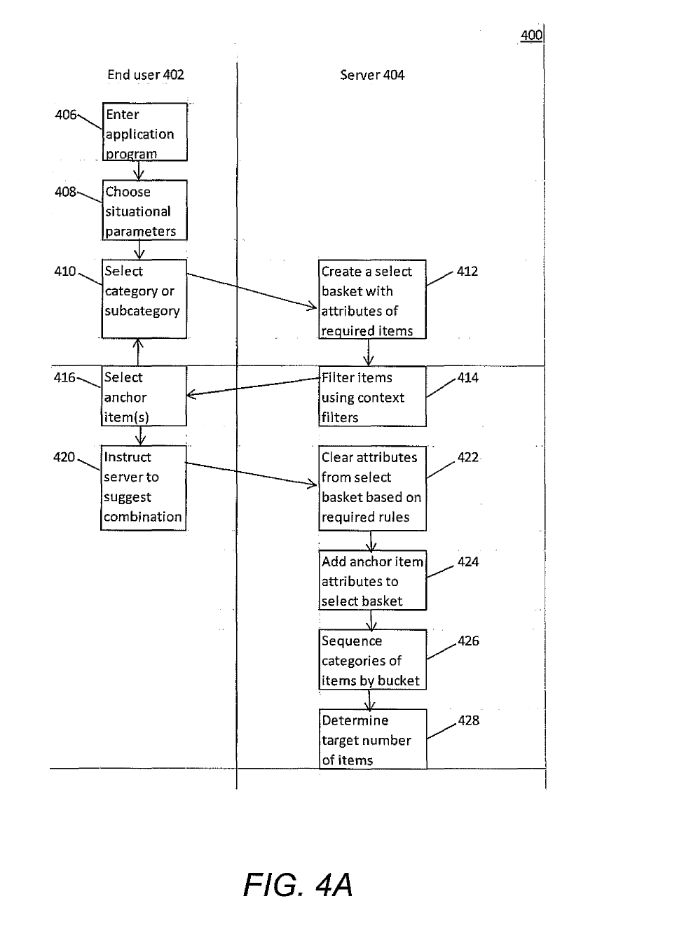

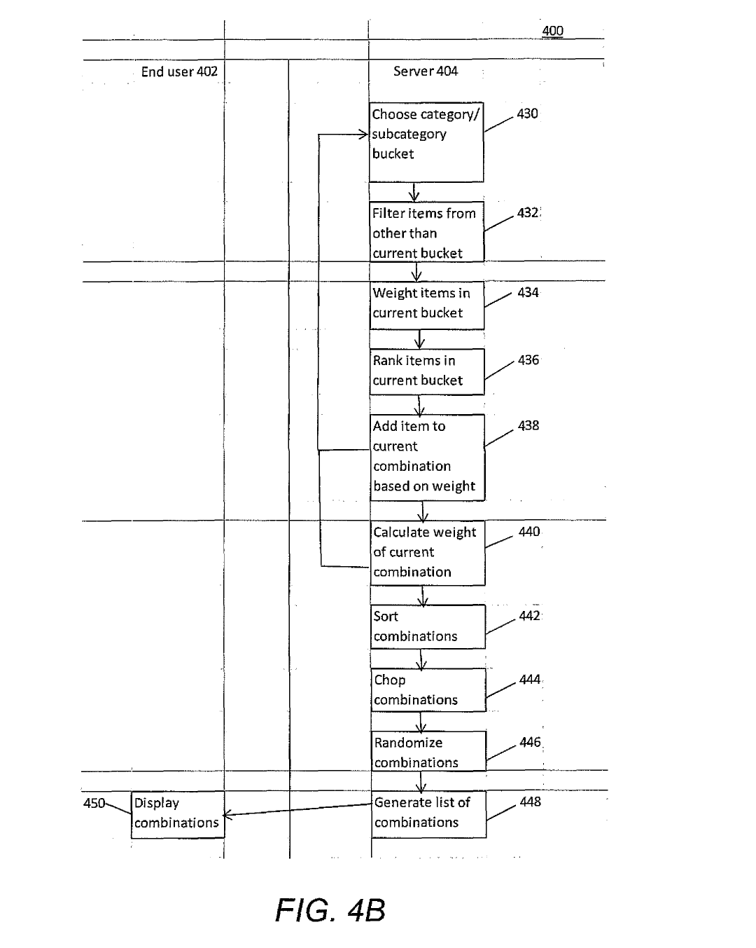

Recommendation engine process 300 provides one example of implementing the teachings herein. FIGS. 4A and 4B show a swim lane diagram of another implementation of a recommendation engine process 400 performed according to the teachings herein. As compared to recommendation engine process 300, FIGS. 4A and 4B include a more detailed description of the interface with the end user, among other differences described below.

For illustrative purposes, FIGS. 4A and 4B include two swim lanes 402, 404 representing recommendation engine process 400. Swim lane 402 represents processing of a program at a location of an end user, such as end-user station 106, while swim lane 404 represents processing of a program to make suggestions to the end user, and which is operating at, for example, server station 102. The programs may both be operating at the same location, but in this example they are programs operating at separate locations, namely end-user station 106 and server station 102. To distinguish between these two programs, the program at end-user station with which the end user interacts is referred to as the application program, while the other program is referred to as the server program.

The end user can take actions (e.g., providing input) by interacting with the application program, which is accessible through a web browser or is running locally by a processor, such as CPU 202, of end-user station 106. The application program may access data stored locally in a database, stored at server station 102 and/or stored in the so-called “cloud” to provide an interface, including selection options, to the end user. The server program is responsive to the user input to provide recommended combinations of items. The server program may include or access certain rules and weights used to make the combinations as described hereinafter as files stored, in this example, in memory 204 or storage device 208 of server station 102.

Certain steps of FIGS. 4A and 4B are duplicative of or overlap steps of FIG. 3. Where such a situation exists, this explanation omits repetitive material contained in the description of FIG. 3.

At step 406, the end user enters the application program by, for example, logging into a website. Optionally, the end user next chooses situational parameters associated with one or more of a season, and occasion and/or a color scheme in step 408. Next, at step 410, the end user can select a category or subcategory to begin the creation of a combination, Step 410 may be an express selection by the end user. In subsequent passes, however, step 410 may be performed responsive to the end user selecting an anchor item in step 416 such that the category and/or subcategory of that item is included in the processing of next steps 412 and 414 until all anchor items are selected by the end user. As mentioned above, limits on the number of anchor items can be defined.

At step 412, a select basket is created containing attributes of required items in a like manner as done in step 304. Then, at step 414, the items available for a combination are filtered similarly to the processing of step 302 except that the select basket attributes are also used to filter the items. After step 414, the end user may select a first anchor item. If the end user selects more than one anchor item, recommendation engine process 400 selects its category and/or subcategory and repeats steps 412 and 414. Once the end user has selected its last anchor item in step 416, the application program instructs the server application to suggest a combination.

At next step 422, recommendation engine process 400 clears attributes from the select basket based on any required rules. According to one aspect, attributes in the select basket based on situation rules, article rules and category combination rules are not affected in this step. The select basket is then modified at step 424 by adding the attributes of the anchor item(s) to the select basket in a like manner as in step 306. At this point, the select basket includes attributes included in step 412 minus the attributes removed in step 422. This aggregate set of attributes may be referred to as a set of selected attributes.

Using the selected attributes and the anchor item(s), recommendation engine process 400 next sequences the categories of items by bucket at step 426. This step is performed in a like manner at step 308. Although not explained in detail in the description of step 308, when more than one anchor item is selected, the consideration of the buckets also changes. The order in the table above is an example where one anchor item is selected. A modification would remove the bucket from the sequence of buckets under consideration for each subsequent anchor item. For example, if the first anchor item is a dress and a second anchor item of a camisole is selected, the order of buckets considered may be: 1) sweater/jacket combined bucket; 2) shoes bucket; 3) handbag bucket; and 4) coat bucket. As another example, if the first anchor item is shoes and the second anchor item is bottoms, the combined bottoms/suits/dresses bucket is not considered in the processing of the buckets under shoes in the table.

At next step 428, a target number of items to place in each bucket level is determined. The target number may be based on a set of system parameters stored in a file accessible to recommendation engine process 400. The target number can be a fixed number for each bucket level. Alternatively, the target number could be a fixed number for each category making up a bucket so that a bucket including three categories has three times as many items as a bucket formed by one category. As another option, each category could have a unique number based on, for example, the number of available items for a combination such that a category with more available items is allowed a higher number of items than a category with fewer available items. Each bucket can then have a target number based on a cumulative total of any categories it includes. A randomizer can be used to select article IDs (and hence the associated items) to include in each bucket using the target number. Other ways of limiting the size of the buckets may be implemented. In an example, recommendation engine process 400 includes only items already acquired by the end user up to the target number.

After step 428, iterative filtering and ranking begins at step 430. The first bucket is chosen for processing in step 430 based on the combination order developed in step 426. For all buckets from which an article has not yet been selected for the combination being built, articles are eliminated that are not desirable to be used based on filters such as situation rules and article rules. This may be similar to step 310 in FIG. 3.

Items in the current bucket that are not currently filtered are next weighted at step 432 and ranked at step 434. Weighting and ranking items were described above with respect to step 312. Recommendation engine process 400 next adds an item from the current bucket to the current combination in step 438. The item is selected based on its weight/rank by, for example, predetermined preferences. According to one embodiment, if the current combination is a first combination, the item may be the top weighted item in the ranking.

Recommendation engine process 400 repeats steps 430-438 until a combination is complete. Assuming that multiple combinations are to be suggested, recommendation engine process 400 repeats steps 430-440 until a maximum number of combinations is reached or until no additional combinations can be generated (e.g., each available item is in a combination with every other remaining available item). The maximum number of combinations may be established beforehand and stored for later access by recommendation engine process 400.

In step 440, the weight of a current combination can be calculated after each combination is finalized in step 438, or the weight of each combination can be calculated after the last combination is finalized in step 438. Regardless of the order of performing step 440, the weights may be calculated in a manner similar to that described with regard to step 316. The combinations are sorted by their total weights in step 442 so that the sorted combinations are arranged in descending order by total weight as in step 316. In step 444, recommendation engine process 400 chops combinations in the manner described with respect to step 318.

The combinations remaining after the chopping step may be randomized in step 446. This is similar to step 320 of FIG. 3. Starting with the randomized list of combinations, a parameter indicating the maximum number of suggestions (e.g., an integer) can be applied to discard combinations above the maximum number in step 448. This generates a final list of combinations to send to the application program. The application program displays the combinations in step 450. The display can be images of the combinations and/or lists of the contents of the combinations.

In an embodiment of the display, a button or other device (either virtual or physical) can be included that will allow the end user to click through to buy merchandise (i.e., one or more suggested items). Similarly, one or more buttons or other input devices can be incorporated into the display to add a complete combination or a particular items to a shopping bag or a wish list (e.g., to share the combination, for example, on a wall, in an e-mail, in an instant message, etc).

In a variation of the examples of FIGS. 3 and 4A, 4B, accessory suggestions could be added to the apparel suggestions by the addition of more buckets for different types of accessories, such as pins, earrings, belts, etc. In each variation, an end user could save combinations for future reference. In another implementation, the ability to click-through to a retailer offering an item in a combination is provided.

Another embodiment of the recommendation engine process may include the feature of skipping items that have a weight below a minimum value. The minimum value may be user-defined. This feature can be used to implement certain user preferences (such as the prohibition on turtlenecks described above). This could also be included in a shopping enhancement that weights items based only on the end user profile, such as physical attributes and preferences. For each rule triggered according the end user profile, the article/item weight can be incremented. As a result, items may have a weight of zero. Each time retailer inventory is uploaded, the weights may be used to display items in descending order according to the article weight. The recommendation engine process may be adjusted to use the article weights so calculated, and the available items can be continuously updated for selecting combinations. Desirably, this would start suggested combinations with items best suited to the end user.

In yet another variation, a different approach to anchor items may be taken. For example, running the required rules to select the best out of the required items may be performed, and the selected item may be used as the first anchor item. This could replace the select basket approach described above.

Error handling can be incorporated into the recommendation engine process. Error handling may address two broad types of errors—errors that stop the process and prevent suggestions from being made and errors that allow the process to continue so as to make suggestions. One error that could stop the recommendation engine process is the end user selection of an anchor item having attribute incompatibilities with another anchor item. One example of this would be the selection of two bottoms as anchor items. Another may be that the logic does not suggest any combinations after step 438. Optionally, when two different, and incompatible, anchor items are suggestion, the recommendation engine process may instead use each anchor item individually to suggest combinations.

Other errors may allow the formation of suggestions. For example, if a required bucket has no items after sequencing in step 426, an error message may be generated for later inclusion in the report of the combination, while that bucket is skipped in generating the combination. Not all buckets need be required. For example, a sweater bucket may not be required, but a bottoms bucket may be required. These settings can vary based on the items being combined. Similarly, an error message may be generated, but the processing continuing, if all available items in a category/subcategory are filtered out, whether or not the associated bucket is required or not. Other error handling may be performed.

The aspects of a recommendation process engine such as those described above with respect to FIGS. 3, 4A, and 4B are examples only. Other implementations are contemplated that can include adding, removing, splitting, combining, or changing steps described above with respect to recommendation engine process 300 and recommendation engine process 400. For example, in certain implementations, steps 310 and/or 432 can include filtering only the current bucket, the bucket after the current bucket, or some other subset of buckets. As another example, steps 310 and/or 432 can be performed at a different time, such as after step 312 or after step 436. In other implementations, the randomization of combinations in steps 322 or step 446 may not be truly random or may include specific selection of one or more highly ranked combinations. In certain implementations, aspects of recommendations engine process 300 and/or 400 can be implemented using other techniques, such as supervised or unsupervised machine learning. For example, the selection of one or more groups of articles can be performed based on previous selections of generated ensembles by the same end-user or by other end-users having one or more common attributes with a current end user.

Various devices, processes, and implementations can utilize recommendation process engines 300 and/or 400, such as, but not limited to, those now described. In an exemplary implementation of an e-mail recommendation engine implemented using, for example, server station 102, a personalized ensemble recommendation e-mail can be generated based on groups of articles or individual articles generated by a recommendation process engine. The e-mail recommendation engine can cause one or more anchor items to automatically be selected. The one or more anchor items can be automatically selected based on, for example, previous selections of items by a user, featured items from one or more retailers, or items from the end-user's closet.

Once selected, the anchor items can be used as input to the recommendation process engine to enable the production of groups of articles. One or more of the generated groups of articles are then selected and used to generate the e-mail including the selected ensembles. The e-mail can include, for example, links for the user to view generated ensembles other than those included in the e-mail or for the user to buy certain articles included in the e-mail not yet in the end-users closet.

Generation of the personalized e-mail can be generated in various ways depending on implementation. For example, the personalized e-mail can be generated on a time-based schedule based on a subscription by the user. The subscription can be an end-user paid service, a free service, or can be based on another's paid service. For example, an end-user can indicate a preference for clothing from a particular retailer, and the retailer can purchase a subscription enabling personalized ensemble notifications to be sent to end-users that include articles from that retailer. Functionality can be provided for the end-user to opt-in or opt-out to such subscription e-mails.

In an alternative or complementary implementation, a gift recommendation engine can be implemented using, for example, server station 102, for providing gift recommendations for an end-user based on articles identified by a recommendation process engine. Depending on the implementation and configuration thereof, a user other than the end-user can request and/or receive the gift recommendation for the end-user. The gift recommendation engine can cause one or more anchor items to automatically be selected. The one or more anchor items can be automatically selected based on, for example, previous selections of items by a user, featured items from one or more retailers, or items from the end-user's closet.

Once selected, the anchor items can be used as input to the recommendation process engine to enable the production of groups of articles. Alternatively or in addition, individual article recommendations can be generated by, for example, not (1) adding the attributes from previously selected articles to the select basket and/or (2) not filtering the current or later buckets based on the attributes in the select basket. The generated articles and/or groups of articles can be limited to articles included in the end-user's boutique, to articles associated with a particular retailer, articles having a price less than, greater than, or between a given price or range of prices, or articles limited based on other defined criteria. One or more of the generated articles and/or groups of articles are then selected and used to generate, for example, an e-mail or webpage to display the gift suggestions. The e-mail can include, for example, links for the user to view generated ensembles other than those included in the e-mail or for the user to buy certain articles included in the e-mail not yet in the end-users closet.

An exemplary implementation for selecting individual articles can include, for example, individually ranking each of a set of available articles using all or some available rules, such as using the techniques described in step 312 above. This process can result in a weight being assigned to each of the set of available articles without, for example, separating the articles into buckets by category. Instead, each article can be weighted individually without regard to the attributes of other articles. In certain implementations, the articles can be weighted individually based on user attributes and situational attributes. Once the weights are assigned, a certain percentage or number of articles can be kept or discarded. Individual articles can then be selected from the remaining articles based on weight order, random selection, or a combination thereof. In certain implementations, the above process can be performed without applying some or all of the available filters (e.g., such as those described with respect to step 310 above). The selection of one or more individual articles, for example, can be used to automatically select an anchor item for input to a recommendation process engine, such as those described above with respect to FIGS. 3, 4A, and 4B.

Generation of the gift e-mail can be generated in various ways depending on implementation. For example, the gift e-mail can be generated on a time-based schedule based on, for example, a birthday of the end-user or a holiday. The subscription can be an end-user paid service, a free service, or can be based on another's paid service. For example, an end-user can indicate a preference for clothing from a particular retailer, and the retailer can purchase a subscription enabling personalized gift suggestions that include articles from that retailer. Functionality can be provided for the end-user or other user to opt-in or opt-out to such subscription e-mails.

As described above, in an implementation, an end-user can provide input to, receive output from, and otherwise interact with a recommendation engine using a web-based interface (e.g., by accessing a website using a web browser). In an alternative or additional implementation, a mobile application (e.g., an “App”) can be provided that provides such functionality on a mobile phone or tablet device, for example. In an exemplary implementation, the App can be run on a device having a camera that can allow for automatic integration of the capture of images to be used in the implementations described herein. In an implementation, the App can utilize a device having a camera, near field communications (NFC) functionality, or the like to automatically identify an article using, for example, barcode, RFID, image recognition, image search, or similar technology. For example, the automatic identification of an article can be used to add an article to an end-user closet or to select an article as the anchor item for generating a group of articles.

In an alternative or additional implementation, an agent of a retailer can access a recommendation engine using a web-based interface (e.g., by accessing a website using a web browser). In an alternative or additional implementation, a mobile application (e.g., an “App”) can be provided that provides functionality to an agent of a retailer on a mobile phone or tablet device, for example. In an implementation, the mobile or web-based application can provide the retail store agent functionality for scanning a loyalty card or otherwise identifying an end-user that, for example, physically visits a retail store location. The retail store agent or end-user can then select an anchor item to enable the generation of ensembles by the recommendation engine using attributes and information associated with the end-user. Alternatively, an anchor article can be automatically selected from the end-user's closet. An attribute associated with the retail store location can be passed to the recommendation engine and included in the select basket to limit selection of articles to those associated with the retailer and/or in stock at the particular retail store location. The generated ensembles and/or items can be displayed to the end-user and/or retail store agent to facilitate identification of articles that the end-user may want to purchase. In some implementations, the web-based or mobile application can provide an indication of the location of the article in the retail store location and/or a quantity of articles in inventory at the retail store location or a nearby retail store location. In some implementations, the web-based or mobile application can provide functionality for physically identifying an article using wireless technology, such as NFC.

In an alternative or complementary implementation, an article recommendation can be generated based on an anchor item. In such an implementation, the anchor item can be, for example, an article that is currently viewed or selected by the end-user. Once identified, the anchor item can be used as input to the recommendation process engine to enable the generation of recommended articles. For example, individual articles can be generated by, not (1) adding the attributes from previously selected articles to the select basket and/or (2) not filtering the current or later buckets based on the attributes in the select basket. Accordingly, multiple articles (or zero articles) can be selected from a given bucket, and/or a single bucket can be utilized. The generated articles can, for example, be limited to articles available for purchase and/or articles from the same retailer, category, or other attribute as the anchor item. One or more of the generated articles and/or groups of articles are then selected and used to generate, for example, an display indication in an e-mail or webpage to display the suggested articles.

As mentioned initially, the teachings herein can be applied to the acquisition and management of various types of items. In one non-limiting alternative example, a combination of cosmetics could be suggested for an end user. In such an application, the application program could prompt the end user to acquire an image of the end user's face upon which suggestions could be displayed. The user profile can include profile data such as eye color or skin tone and preferences such brands, palette (e.g., warm, cool), etc. The profile data, such as eye color or skin tone could be manually entered by the end user in response to prompts of the application program or could be entered automatically. For example, image recognition technology could be used to identify the colors (e.g., RGB) making up the user's eye or skin color. The colors could be translated to skin tone by reference to, for example, a relational database stored in memory 204 relating colors to skin tone and/or to a palette written to the user profile.

Using the user profile and a cosmetics inventory of one or more retailers and/or the end user, suggestions of cosmetics combinations can be made. In an implementation, the suggestions could be displayed on the image of the end user's face. Various combinations could be saved as described with respect to FIG. 3, and the end user could click through to purchase items contained in the suggested combinations. As compared to recommendation engine process 300, the selection of one or more anchor items in step 316 may be omitted, for example.

The teachings herein could also be applied to items such as services. For example, using the teachings with a travel application may reduce the effort involved in planning a family vacation. Desirably, implementing the recommendation engine process to travel would allow user preferences, trip preferences and travel options to be combined into suggestions for a complete itinerary of a trip within cash and/or point budgets. In a similar manner to the processes described above, the end user may save an itinerary and click through to book the suggested itinerary or elements thereof.

Variations of the process described above may be implemented in a travel application. For example, if the end user needs a suggestion on where to go, user profile attributes, location attributes (e.g., city, beach, etc.) and airfare information for selected dates may be combined to rank destinations for display and selection by the end user. Once selected, attributes of the destination may be used as part of the filtering process. For example, the destination may indicate whether or not a rental car is needed. The end user could also manually indicate the need for a rental car through the application program.

Deducting the cost of traveling to the destination, the processes described herein could be used to sort and add rental cars to the combination when a rental car is needed. If a rental car is needed, the cost of the selected car added to the combination is deducted from the total trip budget. Otherwise, no rental car is included in the combination.

The user profile (e.g., number of travelers, age of travelers, etc.) and trip attributes (e.g., type of meals, number of meals, etc.) may next be combined to determine a budget allocation between remaining categories. For example, the next bucket may contain a hotel category. Hotel options may be obtained through the filter and rank processing described above. The item (i.e., the hotel) is then selected based on its rank, the cost is deducted from the total budget, and the remaining budget is reallocated among remaining categories such as dining.

When dining is the category in the next bucket, for example, dining options for each meal can be determined through the filter and rank processing. The cost of all meals (possibly multiplied by the number of travelers) can then be deducted from total budget. Any remaining budget can be reallocated among any remaining categories. Assuming a final bucket contains a single category of entertainment, entertainment options can be found through the filter and rank processing. The cost of the selected item or items (i.e., one or more entertainment activities) may be limited by the remaining budget after meals.

Various combinations may be proposed as limited by the total budget. In such an implementation, it may be desirable to exclude anchor items. For example, the destination may be designated as an anchor item in the process described above. However, omitting such a designation may allow a variety of travel destinations that share similar attributes to be included in the combinations. In this way, a more complete itinerary may be determined in one location as opposed to another based on the total budget.

In a variation of this implementation, distances between hotel, dining and entertainment options may be calculated to check the feasibility of an end user's travel schedule. Desirably, but not necessarily, the recommendation engine process could be integrated with loyalty points programs, such as by assigning a value to booking a provider associated with the program as opposed to a non-program provider, or by using an assigned value to points to determine the better value of using points as compared to using cash.

With respect to goods, and as mentioned above, the teachings may be applied to goods not conventionally considered consumable. For example, the teachings herein may be applied to a landscaping application through the combination, filtering and ranking of landscaping items (e.g., trees, shrubs, flowers, etc.) using end user attributes, land attributes and retailer inventories. The combinations may be suggested items for a landscaping landscape plan that can be saved by the end user. Clicking-through to purchase items may be an option.

In more detail, for example, a user profile and landscaping area attributes can be combined to determine budget allocation between categories (e.g., buckets). The recommendation engine process can be modified so that, after each filter and rank step, or as part of the ranking process, a desired quantity can be multiplied by a price. The selection in each bucket may be based on an order specific to landscaping, such as trees being considered before flowers and grass. The cost of the selections for the combination may be deducted from a total budget after each selection so as to calculate and reallocate any remaining budget. If a budget is not set by a user, the cost of the selections may not be considered in the selections, even if a total price is calculated. With regard to click-through options, the end user can be provided the capability of clicking a button to purchase a selected plan or components thereof for in-store pick-up or delivery. A button can also be presented by the application program to allow the user to find contractors for installation assistance.

The above examples relating to total budget across categories may also be applied to other items, such as fashion articles and for the selection of fashion ensembles.

In addition to the foregoing, the teachings herein may be applied to goods to a wine/pantry/entertainment application. In such an application, the processing described herein may be used to suggest a complete menu for an end user. For example, items in an end user's pantry, an end user profile (e.g., vegetarian, etc.), recipes and event information may be combined to suggest a complete menu that maximizes use of what the end user already has in the pantry so that the menu aligns with an intended theme, event size and user preferences.

The suggest combinations in such an application can be the complete menu (e.g., using recipes as the items to be combined) and/or individual recipes (e.g., using the ingredients as the items to be combined). For example, user profile attributes, anchor item(s), quantity (if desired) and number of diners (if desired) may be used in the filtering and ranking steps to identify applicable recipes as combinations of ingredients. Ranking a combination may be based on the items (e.g., ingredients) already in the end user's pantry. In one implementation, a recipe may be ranked on the percentage of required ingredients already in the pantry. Drink recommendations can be made for a meal or each course of a meal by including beverages in one or more buckets. Alternatively, food and drink menus can be generate by separate filter and rank processing and then may be combined for display in a three-member array.

Optionally, the recommendation engine process saves the menu and allows the user to use a click-through button or other device to make purchases of food and/or beverages for in-store pick-up or delivery where available. This could be accomplished by an addition to the recommendation engine process that, for example, decomposes recipes into ingredients list and checks whether the end user has sufficient ingredients already. For those not already in user's pantry or already in user's pantry in insufficient quantities, an addition may be made to a grocery list. The grocery list may be added with required purchase quantities to the display of each of the combinations.

In an additional option, the selected menu could be used to suggest decor and other tips from a set of rules tied to the attributes of the selected menu and user profile.

A food service management application can also be implemented using the teachings herein. Such an application could suggest a complete menu that minimizes waste and achieves quantity goals by considering inputs such as the end user's inventory and an intended number of servings. A similar process to that described with respect to the wine/pantry/entertainment application may be followed with the inclusion of a step of, between each filter and rank process, calculating remaining quantities of unused ingredients and using that as a weight for selecting a recipe in the next bucket that maximizes the use of remaining ingredients.

Once various combinations are formed, the remaining quantities of unused ingredients and the number of servings a menu will provide can be calculated. These values may be used in the ranking of the menus so as to, for example, rank menus with fewer unused ingredients and more servings higher than those menus with larger amounts of unused ingredients and less servings.

Optionally, a request to begin preparation could be automatically issued by the recommendation engine process. The process may be modified to allow an end user to click a button to communicate a selected menu to chefs and/or to order necessary additional ingredients for delivery.

Implementations of server station 102 and/or end user station 106 (and the algorithms, methods, instructions, etc., stored thereon and/or executed thereby) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of server station 102 and end user station 106 do not necessarily have to be implemented in the same manner.

Further, in one aspect, for example, server station 102 or end user station 106 can be implemented using a general purpose computer or general purpose processor with a computer program that, when executed, carries out any of the respective methods, algorithms and/or instructions described herein. In addition or alternatively, for example, a special purpose computer/processor can be utilized that can contain other hardware for carrying out any of the methods, algorithms, or instructions described herein.

Server station 102 and end user station 106 can, for example, be implemented on computers across a network. Alternatively or in addition, server station 102 can be implemented on a server and end user station 106 can be implemented on a device separate from the server, such as a hand-held communications device. Other suitable implementation schemes are available. In another implementation, server station 102 and end user station 106 may be the same computing device.

Further, all or a portion of implementations of the present invention can take the form of a computer program product accessible from, for example, a tangible computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations and aspects have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

1. A method for generating one or more groups of articles for one or more ensembles based on at least one anchor article, the method comprising:
adding at least one attribute of the at least one anchor article to a set of selected attributes;
defining a sequence of buckets in an order based on a category of the at least one anchor article, wherein each of the buckets include selected articles of a set of available articles belonging to at least one category of a plurality of categories; and
generating a current group of articles of the one or more groups of articles by adding the at least one anchor article to the current group of articles and performing the following steps until each bucket of the sequence of buckets has been selected:
selecting a current bucket from the sequence of buckets based on the order of buckets;
applying a filter to at least one of the current bucket or a later bucket of the sequence of buckets to remove articles having at least one attribute determined to be incompatible with at least one attribute in the set of selected attributes;
calculating a weight for at least some articles in the current bucket based on one or more rules and the set of selected attributes;
selecting an article from the current bucket for inclusion in the current group of articles based on a ranking of articles according to the calculated weights; and
adding at least one attribute of the selected article from the current bucket to the set of selected attributes.

2. The method of claim 1, further comprising:
generating a graphical user interface to display at least some of the set of available articles to a user;
receiving a selection of the at least one anchor article from an end-user from the displayed set of available articles; and
generating a graphical user interface to display the one or more ensembles based on the generated one or more groups of articles.

3. The method of claim 2, wherein the set of available articles is generated from a set of articles associated with an end-user's closet and a set of articles associated with boutique of articles available for purchase, wherein the boutique of articles available for purchase is filtered from a universe of articles available for purchase based on one or more user attributes.

4. The method of claim 1, wherein the set of available articles is generated from at least one of a set of articles associated with an end-user's closet and a set of articles associated with boutique of articles available for purchase, wherein the boutique of articles available for purchase is filtered from a universe of articles available for purchase based on one or more user attributes.

5. The method of claim 1, wherein:
at least one of the one or more rules includes a total budget price and a remaining budget price for the current group of articles;
selecting the article includes subtracting a price of the selected article from the remaining budget price for the current group of articles; and
calculating the weight based on the at least one rule is based on a price of the article and the remaining budget price.

6. The method of claim 1, wherein generating the current group of articles includes calculating a weight of the current group of articles based on the calculated weights of articles included in the current group of articles, the method further comprising:
iteratively generating a plurality of additional groups of articles of the one or more groups of articles, wherein generating an additional group of articles includes calculating a weight of the additional group of articles based on the calculated weights of articles included in the additional group of articles.
selecting a predetermined number of the one or more groups of articles based on the weights of the groups of articles.

7. The method of claim 6, wherein selecting the predetermined number of the one or more groups of articles based on the weights of the groups of articles comprises:
discarding groups of articles having a weight less than a defined value; and
randomly selecting the predetermined number of the one or more groups of articles from the groups of articles that have not been discarded.

8. The method of claim 7, further comprising:
receiving an ensemble suggestion subscription request from an end-user;
automatically selecting the at least one anchor article from a set of articles associated with an end-user's closet;
generating a personalized e-mail including images associated with ensembles based on the selected groups of articles; and
sending the personalized e-mail to an e-mail address associated with the end-user.

9. The method of claim 7, further comprising:
receiving a gift suggestion request from a third-party user for a gift suggestion for an end-user;
automatically selecting the at least one anchor article from a set of articles associated with an end-user's closet; and
generating a graphical user interface to display at least one ensemble based on the selected groups of articles.

10. The method of claim 1, wherein calculating the weight for at least some articles in the current bucket based on the one or more rules and the set of selected attributes includes:
selecting a category combination rule;
jointly evaluating attributes in the set of selected attributes associated with two or more previously selected articles; and
weighting at least some articles in the current bucket based on the joint evaluation.

11. The method of claim 1, wherein calculating the weight for at least some articles in the current bucket based on the one or more rules and the set of selected attributes includes:
selecting a situational rule;
evaluating at least one of a season, occasion, color scheme, or end-user attribute against an article in the current bucket using the selected situational rule; and
weighting the article based on the evaluation.

12. The method of claim 1, wherein the available set of articles is selected from a set of articles associated with an end-user's closet and a set of articles associated with boutique of articles available for purchase, wherein the selection is based on one or more situational rules associated with at least one of a season, occasion, color scheme, or end-user attribute.

13. (canceled)

14. The method of claim 1, further comprising:
receiving an identifier associated with an end-user obtained by a retail store agent;
receiving an identifier associated with a retail store location at which the retail store agent is located;
automatically selecting the at least one anchor article from a set of articles associated with an end-user's closet;
adding an attribute associated with the retail store location to the set of selected attributes; and
sending information to the retail store agent associated with at least one ensemble based on the selected groups of articles.

15. An apparatus for generating one or more groups of articles for one or more ensembles based on at least one anchor article, the apparatus comprising:
a memory; and
a processor configured to execute instructions stored in the memory to:
add at least one attribute of the at least one anchor article to a set of selected attributes;
define a sequence of buckets in an order based on a category of the at least one anchor article, wherein each of the buckets include selected articles of a set of available articles belonging to at least one category of a plurality of categories; and
generate a current group of articles of the one or more groups of articles by adding the at least one anchor article to the current group of articles and performing the following steps until each bucket of the sequence of buckets has been selected:
select a current bucket from the sequence of buckets based on the order of buckets;
apply a filter to at least one of the current bucket or a later bucket of the sequence of buckets to remove articles having at least one attribute determined to be incompatible with at least one attribute in the set of selected attributes;
calculate a weight for at least some articles in the current bucket based on one or more rules and the set of selected attributes;
select an article from the current bucket for inclusion in the current group of articles based on a ranking of articles according to the calculated weights; and
add at least one attribute of the selected article from the current bucket to the set of selected attributes.

16. The apparatus of claim 15, wherein the instructions to select the predetermined number of the one or more groups of articles based on the weights of the groups of articles includes instructions to:
discard groups of articles having a weight less than a defined value; and
randomly select the predetermined number of the one or more groups of articles from the groups of articles that have not been discarded.

17. The apparatus of claim 16, further including instructions to:
receive an ensemble suggestion subscription request from an end-user;
automatically select the at least one anchor article from a set of articles associated with an end-user's closet;
generate a personalized e-mail including images associated with ensembles based on the selected groups of articles; and
send the personalized e-mail to an e-mail address associated with the end-user.

18. The apparatus of claim 16, further including instructions to:
receive a gift suggestion request from a third-party user for a gift suggestion for an end-user;
automatically select the at least one anchor article from a set of articles associated with an end-user's closet; and
generate a graphical user interface to display at least one ensemble based on the one or more groups of articles.

19. The apparatus of claim 15, wherein the instructions to calculate the weight for at least some articles in the current bucket based on the one or more rules and the set of selected attributes includes instructions to:
select a category combination rule;
jointly evaluate attributes in the set of selected attributes associated with two or more previously selected articles; and
weight at least some articles in the current bucket based on the joint evaluation.

20. The apparatus of claim 15, wherein the instructions to calculate the weight for at least some articles in the current bucket based on the one or more rules and the set of selected attributes includes instructions to:
select a situational rule;
evaluate at least one of a season, occasion, color scheme, or end-user attribute against an article in the current bucket using the selected situational rule; and
weight the article based on the evaluation.

21. A non-transitory computer readable medium including computer readable instructions for generating one or more groups of articles for one or more ensembles based on at least one anchor article; wherein the instructions, when executed by a processor, cause the processor to:
add at least one attribute of the at least one anchor article to a set of selected attributes;
define a sequence of buckets in an order based on a category of the at least one anchor article, wherein each of the buckets include selected articles of a set of available articles belonging to at least one category of a plurality of categories; and
generate a current group of articles of the one or more groups of articles by adding the at least one anchor article to the current group of articles and performing the following steps until each bucket of the sequence of buckets has been selected:
select a current bucket from the sequence of buckets based on the order of buckets;
apply a filter to at least one of the current bucket or a later bucket of the sequence of buckets to remove articles having at least one attribute determined to be incompatible with at least one attribute in the set of selected attributes;
calculate a weight for at least some articles in the current bucket based on one or more rules and the set of selected attributes;
select an article from the current bucket for inclusion in the current group of articles based on a ranking of articles according to the calculated weights; and
add at least one attribute of the selected article from the current bucket to the set of selected attributes.

22-41. (canceled)
